(19) United States
(12) Patent Application Publication
(10) Pub. No.: US 2024/0309134 A1
(43) Pub. Date: Sep. 19, 2024

(54) USE OF RANDOM PROPYLENE ETHYLENE COPOLYMERS FOR BIAXIALLY ORIENTED FILMS

(71) Applicant: Basell Poliolefine Italia S.r.l., Milano (IT)

(72) Inventors: Marco Bocchino, Ferrara (IT); Davide Tartari, Ferrara (IT); Alberto Nardin, Ferrara (IT); Benedetta Gaddi, Ferrara (IT); Gianni Colina, Ferrara (IT); Nicola Pazi, Ferrara (IT)

(73) Assignee: Basell Poliolefine Italia S.r.l., Milano (IT)

(21) Appl. No.: 18/577,637

(22) PCT Filed: Jun. 24, 2022
(86) PCT No.: PCT/EP2022/067449

§ 371 Date: Jan. 8, 2024

(30) Foreign Application Priority Data
Jul. 9, 2021 (EP) 21184914.6

(51) Int. Cl. C08F 210/06; C08J 5/18

(52) U.S. Cl. CPC C08F 210/06; C08J 5/18; C08J 2323/16

(57) ABSTRACT

A biaxially oriented polypropylene (BOPP) film made from or containing a copolymer of propylene and ethylene having:
i) the content of ethylene derived units ranging from 0.5 wt % to 2.2 wt %;
ii) a xylene soluble fraction at 25°° C. ranging from 4.3 wt % to 6.5 wt %; and
iii) a melt flow rate, MFR, measured according to ISO 1133-1:2012 at 230° C. with a load of 2.16 kg, ranging from 0.5 g/10 min to 7.0 g/10 min.

### FIELD OF THE INVENTION

In general, the present disclosure relates to the field of chemistry. More specifically, the present disclosure relates to polymer chemistry. In particular, the present disclosure relates to a propylene ethylene copolymer and biaxially-oriented polypropylene (BOPP) films made therefrom.

### BACKGROUND OF THE INVENTION

In some instances, propylene, ethylene copolymers are used for preparing biaxially oriented polypropylene (BOPP) films. In some instances, the BOPP films are used for the packaging of foodstuff, using automatic machines.

### SUMMARY OF THE INVENTION

In a general embodiment, the present disclosure provides a biaxially oriented polypropylene (BOPP) film made from or containing:

a copolymer of propylene and ethylene having
i) the content of ethylene derived units, measured by 13C NMR, ranging from 0.5 wt % to 2.2 wt %, based upon the total weight of the copolymer;
ii) a xylene soluble fraction at 25° C. ranging from 4.3 wt % to 6.5 wt %, based upon the total weight of the copolymer; and
iii) a melt flow rate, MFR, measured according to ISO 1133-1:2012 at 230° C. with a load of 2.16 kg, ranging from 0.5 g/10 min to 7.0 g/10 min.

### DETAILED DESCRIPTION OF THE INVENTION

In some embodiments, the present disclosure provides a biaxially oriented polypropylene (BOPP) film made from or containing:

a copolymer of propylene and ethylene having
i) the content of ethylene derived units, measured by ¹³C NMR, ranging from 0.5 wt % to 2.2 wt %; alternatively from 0.6 wt % to 1.8 wt %; alternatively from 0.7 wt % to 1.4 wt %, based upon the total weight of the copolymer;
ii) the xylene soluble fraction at 25° C. ranging from 4.3 wt % to 6.5 wt %; alternatively from 4.6 wt % to 6.1 wt %; alternatively from 4.8 wt % to 5.7 wt %, based upon the total weight of the copolymer; and
iii) the melt flow rate, MFR, measured according to ISO 1133-1:2012 at 230° C. with a load of 2.16 kg, ranging from 0.5 g/10 min to 7.0 g/10 min; alternatively from 1.0 g/10 min to 6.0 g/10 min; alternatively from 1.5 g/10 min to 4.5 g/10 min.

As used herein, the term “copolymer refers to polymers containing propylene and ethylene, in the absence of other monomers. Propylene homopolymer is not present in the copolymer of propylene and ethylene of the present disclosure.

In some embodiments, the BOPP film is made from or containing the copolymer of propylene and ethylene of the present disclosure. During the process for producing the BOPP film, the stretchability of the resulting film is improved in terms of temperature, thereby increasing the processability as well as improving the mechanical and optical properties in comparison with a BOPP made from or containing a propylene homopolymer.

In some embodiments, the copolymer of propylene and ethylene is obtainable by polymerizing propylene and ethylene, in the presence of a catalyst system made from or containing a product obtained by contacting (a) a solid catalyst component, having an average particle size ranging from 15 to 80 μm and made from or containing a magnesium halide, a titanium compound having at least a Ti-halogen bond, and an internal electron donor compound, (b) an aluminum hydrocarbyl compound, and optionally (c) an external electron donor compound. In some embodiments, the internal electron donor compound of the solid catalyst component is selected from the group consisting of succinates and 1,3 diethers. In some embodiments, catalyst system is free of an external electron donor compound.

In some embodiments, the succinate has the formula (I) below

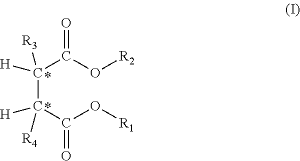

wherein the radicals R₁ and R₂, equal to or different from each other, are a C₁-C₂₀ linear or branched alkyl, alkenyl, cycloalkyl, aryl, arylalkyl, or alkylaryl group, optionally containing heteroatoms; and the radicals R₃ and R₄, equal to or different from each other, are C₁-C₂₀ alkyl, C₃-C₂₀ cycloalkyl, C₅-C₂₀ aryl, arylalkyl, or alkylaryl group, providing that R₃, R₄, or both are a branched alkyl. In some embodiments, the compounds are, with respect to the two asymmetric carbon atoms identified in the structure of formula (I), stereoisomers of the type (S,R) or (R,S)

In some embodiments, R₁ and R₂ are selected from the group consisting of C₁-C₈ alkyl, cycloalkyl, aryl, arylalkyl, and alkylaryl groups. In some embodiments, R₁ and R₂ are selected from primary alkyls, alternatively branched primary alkyls. In some embodiments, R₁ and R₂ groups are selected from the group consisting of methyl, ethyl, n-propyl, n-butyl, isobutyl, neopentyl, 2-ethylhexyl. In some embodiments, R₁ and R₂ groups are selected from the group consisting of ethyl, isobutyl, and neopentyl.

In some embodiments, R₃, R₄, or both radicals are secondary alkyls or cycloalkyls. In some embodiments, the secondary alkyls are selected from the group consisting of isopropyl, sec-butyl, 2-pentyl, and 3-pentyl. In some embodiments, the cycloalkyls are selected from the group consisting of cyclohexyl, cyclopentyl, and cyclohexylmethyl.

In some embodiments, the compounds are the (S,R) (S,R) forms pure or in mixture, optionally in racemic form, of compounds selected from the group consisting of diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2,3-bis(cyclohexylmethyl)succinate, diethyl 2,3-diisobutylsuccinate, diethyl 2,3-dineopentylsuccinate, diethyl 2,3-dicyclopentylsuccinate, and diethyl 2,3-dicyclohexylsuccinate.

In some embodiments, the 1,3-diethers have formula (II)

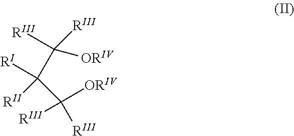

wherein R^{I} and R^{II} are the same or different and are hydrogen or linear or branched C₁-C₁₈ hydrocarbon groups; R^{III} groups, equal or different from each other, are hydrogen or C₁-C₁₈ hydrocarbon groups; R^{IV} groups, equal or different from each other, have the same meaning of R^{III} except that R^{IV} groups are not hydrogen. In some embodiments, R^{I} or R^{II} has constituents which form cyclic structures. In some embodiments, each of R^{I} to R^{IV} groups contain heteroatoms selected from the group consisting of halogens, N, O, S and Si.

In some embodiments, R^{IV} is a 1-6 carbon atom alkyl radical, alternatively a methyl. In some embodiments, the R^{III} radicals are hydrogen. In some embodiments, R^{I} is selected from the group consisting of methyl, ethyl, propyl, and isopropyl while R^{II} is selected from the group consisting of ethyl, propyl, isopropyl, butyl, isobutyl, tert-butyl, isopentyl, 2-ethylhexyl, cyclopentyl, cyclohexyl, methylcyclohexyl, phenyl, and benzyl. In some embodiments, R^{I} is hydrogen while R^{II} is selected from the group consisting of ethyl, butyl, sec-butyl, tert-butyl, 2-ethylhexyl, cyclohexylethyl, diphenylmethyl, p-chlorophenyl, 1-naphthyl, and 1-decahydronaphthyl. In some embodiments, R^{I} and R^{II} are the same and selected from the group consisting of ethyl, propyl, isopropyl, butyl, isobutyl, tert-butyl, neopentyl, phenyl, benzyl, cyclohexyl, and cyclopentyl.

In some embodiments, the 1,3-diethers are selected from the group consisting of 2-(2-ethylhexyl)1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2-(2-cyclohexylethyl)-1,3-dimethoxypropane, 2-(p-chlorophenyl)-1,3-dimethoxypropane, 2-(diphenylmethyl)-1,3-dimethoxypropane, 2(1-naphthyl)-1,3-dimethoxypropane, 2(p-fluorophenyl)-1,3-dimethoxypropane, 2(1-decahydronaphthyl)-1,3-dimethoxypropane, 2(p-tert-butylphenyl)-1,3-dimethoxypropane, 2,2-dicyclohexyl-1,3-dimethoxypropane, 2,2-diethyl-1,3-dimethoxypropane, 2,2-dipropyl-1,3-dimethoxypropane, 2,2-dibutyl-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2-methyl-2-phenyl-1,3-dimethoxypropane, 2-methyl-2-cyclohexyl-1,3-dimethoxypropane, 2-methyl-2-methylcyclohexyl-1,3-dimethoxypropane, 2,2-bis(p-chlorophenyl)-1,3-dimethoxypropane, 2,2-bis(2-phenylethyl)-1,3-dimethoxypropane, 2,2-bis(2-cyclohexylethyl)-1,3-dimethoxypropane, 2-methyl-2-isobutyl-1,3-dimethoxypropane, 2-methyl-2-(2-ethylhexyl)-1,3-dimethoxypropane, 2,2-bis(2-ethylhexyl)-1,3-dimethoxypropane,2,2-bis(p-methylphenyl)-1,3-dimethoxypropane, 2-methyl-2-isopropyl-1,3-dimethoxypropane, 2,2-diisobutyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 2-isobutyl-2-isopropyl-1,3-dimetoxypropane, 2,2-di-sec-butyl-1,3-dimetoxypropane, 2,2-di-tert-butyl-1,3-dimethoxypropane, 2,2-dineopentyl-1,3-dimethoxypropane, 2-iso-propyl-2-isopentyl-1,3-dimethoxypropane, 2-phenyl-2-benzyl-1,3-dimetoxypropane, and 2-cyclohexyl-2-cyclohexylmethyl-1,3-dimethoxypropane.

In some embodiments, the 1,3-diethers have formula (III)

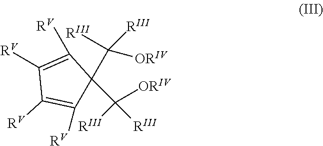

wherein the radicals R^{IV} have the same meaning defined in formula (II) and the radicals R^{III} and R^{V} radicals, equal or different to each other, are selected from the group consisting of hydrogen; halogens; C₁-C₂₀ alkyl radicals, linear or branched; C₃-C₂₀ cycloalkyl, C₆-C₂₀ aryl, C₇-C₂₀ alkaryl, and C₇-C₂₀ aralkyl radicals. In some embodiments, two or more of the R^{IV} radicals are bonded to each other to form condensed cyclic structures, saturated or unsaturated, optionally substituted with R^{VI} radicals. In some embodiments, R^{VI} radicals are selected from the group consisting of halogens; C₁-C₂₀ alkyl radicals, linear or branched; C₃-C₂₀ cycloalkyl, C₆-C₂₀ aryl, C₇-C₂₀ alkylaryl and C7-C20 arylalkyl radicals. In some embodiments, the halogens are selected from the group consisting of Cl and F. In some embodiments, the radicals R^{V} and R^{VI} contain one or more heteroatoms as substitutes for carbon or hydrogen atoms, or both.

In some embodiments and in the 1,3-diethers of formulae (I) and (II), the R^{III} radicals are hydrogen, and the R^{IV} radicals are methyl. In some embodiments, the 1,3-diethers of formula (II) have two or more of the R^{V} radicals bonded to each other, thereby forming one or more condensed cyclic structures, optionally substituted by R^{VI} radicals. In some embodiments, the condensed cyclic structures are benzenic. In some embodiments, the 1,3-diethers have formula (IV):

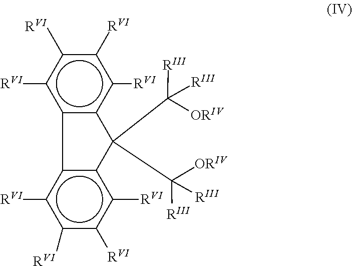

wherein the R^{VI} radicals equal or different are hydrogen; halogens; C₁-C₂₀ alkyl radicals, linear or branched; C₃-C₂₀ cycloalkyl, C₆-C₂₀ aryl, C₇-C₂₀ alkylaryl, and C₇-C₂₀ aralkyl radicals, optionally containing one or more heteroatoms selected from the group consisting of N, O, S, P, Si, and halogens, as substitutes for carbon or hydrogen atoms, or both; the radicals R^{III} and R^{IV} are as defined above for formula (III). In some embodiments, the halogens are selected from the group consisting of Cl and F.

In some embodiments, the 1,3-diethers of formulae (III) and (IV) are selected from the group consisting of:
1,1-bis(methoxymethyl)-cyclopentadiene;
1,1-bis(methoxymethyl)-2,3,4,5-tetramethylcyclopentadiene;
1,1-bis(methoxymethyl)-2,3,4,5-tetraphenylcyclopentadiene;
1,1-bis(methoxymethyl)-2,3,4,5-tetrafluorocyclopentadiene;
1,1-bis(methoxymethyl)-3,4-dicyclopentylcyclopentadiene;
1,1 --bis(methoxymethyl)indene; 1,1-bis(methoxymethyl)-2,3-dimethylindene;
1,1-bis(methoxymethyl)-4,5,6,7-tetrahydroindene;
1,1-bis(methoxymethyl)-2,3,6,7-tetrafluoroindene;
1,1-bis(methoxymethyl)-4,7-dimethylindene;
1,1-bis(methoxymethyl)-3,6-dimethylindene;
1,1-bis(methoxymethyl)-4-phenylindene;
1,1-bis(methoxymethyl)-4-phenyl-2-methylindene;
1,1-bis(methoxymethyl)-4-cyclohexylindene;
1,1-bis(methoxymethyl)-7-(3,3,3-trifluoropropyl)indene;
1,1-bis(methoxymethyl)-7-trimethyisilylindene;
1,1-bis(methoxymethyl)-7-trifluoromethylindene;
1,1-bis(methoxymethyl)-4,7-dimethyl-4,5,6,7-tetrahydroindene;
1,1-bis(methoxymethyl)-7-methylindene;
1,1-bis(methoxymethyl)-7-cyclopenthylindene;
1,1-bis(methoxymethyl)-7-isopropylindene;
1,1-bis(methoxymethyl)-7-cyclohexylindene;
1,1-bis(methoxymethyl)-7-tert-butylindene;
1,1-bis(methoxymethyl)-7-tert-butyl-2-methylindene;
1,1-bis(methoxymethyl)-7-phenylindene;
1,1-bis(methoxymethyl)-2-phenylindene;
1,1-bis(methoxymethyl)-1H-benz[e]indene;
1,1-bis(methoxymethyl)-1H-2-methylbenz[e]indene;
9,9-bis(methoxymethyl)fluorene;
9,9-bis(methoxymethyl)-2,3,6,7-tetramethylfluorene;
9,9-bis(methoxymethyl)-2,3,4,5,6,7-hexafluorofluorene;
9,9-bis(methoxymethyl)-2,3-benzofluorene;
9,9-bis(methoxymethyl)-2,3,6,7-dibenzofluorene;
9,9-bis(methoxymethyl)-2,7-diisopropylfluorene;
9,9-bis(methoxymethyl)-1,8-dichlorofluorene;
9,9-bis(methoxymethyl)-2,7-dicyclopentylfluorene;
9,9-bis(methoxymethyl)-1,8-difluorofluorene;
9,9-bis(methoxymethyl)-1,2,3,4-tetrahydrofluorene;
9,9-bis(methoxymethyl)-1,2,3,4,5,6,7,8-octahydrofluorene; and
9,9-bis(methoxymethyl)-4-tert-butylfluorene.

In some embodiments, the catalyst component (a) is made from or containing an internal electron donor, a titanium compound having a Ti-halogen bond, and an Mg halide. In some embodiments, the magnesium halide is MgCl₂ in active form.

In some embodiments, the titanium compounds are selected from the group consisting of TiCl₄ and TiCl₃. In some embodiments, the titanium compounds are Ti-haloalcoholates having formula Ti(OR)_{n-y}X_{y}, where n is the valence of titanium, y is a number between 1 and n−1, X is halogen, and R is a hydrocarbon radical having from 1 to 10 carbon atoms.

In some embodiments, the catalyst component (a) has an average particle size ranging from 20 to 70 μm, alternatively from 25 to 65 μm. In some embodiments, the succinate is present in an amount ranging from 50 to 90% by weight with respect to the total amount of donors. In some embodiments, the amount of succinate ranges from 60 to 85% by weight, alternatively from 65 to 80% by weight. In some embodiments, the 1,3-diether constitutes the remaining amount.

In some embodiments, aluminum hydrocarbyl compound (b) is an aluminum hydrocarbyl compound, wherein the hydrocarbyl is selected from C₃-C₁₀ branched aliphatic or aromatic radicals. In some embodiments, the hydrocarbyl is a branched aliphatic radical, alternatively selected from branched trialkyl aluminum compound. In some embodiments, the branched trialkyl aluminum compounds are selected from the group consisting of triisopropylaluminum, tri-iso-butylaluminum, tri-iso-hexylaluminum, and tri-iso-octylaluminum. In some embodiments, mixtures of branched trialkylaluminums are used with alkylaluminum halides, alkylaluminum hydrides, or alkylaluminum sesquichlorides. In some embodiments, alkylaluminum sesquichlorides are selected from the group consisting of AlEt₂Cl and Al₂Et₃Cl₃.

In some embodiments, external electron-donor compounds are selected from the group consisting of silicon compounds, ethers, esters, amines, heterocyclic compounds, ketones, and the 1,3-diethers. In some embodiments, the ester is ethyl 4-ethoxybenzoate. In some embodiments, the heterocyclic compound is 2,2,6,6-tetramethyl piperidine. In some embodiments, the silicon compounds have formula Rₐ⁵R_{b}⁶Si(OR⁷)_{c}, wherein a and b are integer from 0 to 2, c is an integer from 1 to 3, and the sum (a+b+c) is 4; R⁵, R⁶, and R⁷ are alkyl, cycloalkyl, or aryl radicals with 1-18 carbon atoms optionally containing heteroatoms. In some embodiments, the silicon compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane and 1,1,1,trifluoropropyl-2-ethylpiperidinyl-dimethoxysilane, and 1,1,1, trifluoropropyl-methyl-dimethoxysilane. In some embodiments, the amount of external electron donor compound provides a molar ratio between the aluminum hydrocarbyl compound and the electron donor compound of from 5 to 500, alternatively from 5 to 400, alternatively from 10 to 200.

In some embodiments, the catalyst forming components are contacted with a liquid inert hydrocarbon solvent, at a temperature below about 60° C., alternatively from about 0 to 30° C., for a time period of from about six seconds to 60 minutes. In some embodiments, the liquid inert hydrocarbon solvent is propane, n-hexane, or n-heptane.

In some embodiments, the catalyst components (a), (b), and optionally (c) are fed to a pre-contacting vessel, in amounts such that the weight ratio (b)/(a) is in the range of 0.1-10. In some embodiments, compound (c) is present, and the weight ratio (b)/(c) is weight ratio of from 5 to 500, alternatively from 5 to 400, alternatively from 10 to 200. In some embodiments, the components are pre-contacted at a temperature of from 10 to 20° C., for 1-30 minutes. In some embodiments, the precontact vessel is a stirred tank or a loop reactor.

In some embodiments, the copolymer of propylene and ethylene is obtained by a polymerizing process carried out in a reactor having two interconnected polymerization zones, a riser and a downcomer, wherein the growing polymer particles:
(a) flow through the first polymerization zone, the riser, under fast fluidization conditions, in the presence of propylene, ethylene, and 1-butene;
(b) leave the riser and enter the second polymerization zone, the downcomer, through which the growing polymer particles flow downward in a densified form, in the presence of propylene, ethylene, and 1-butene, wherein the concentration of ethylene in the downcomer is higher than in the riser; and
(c) leave the downcomer and are reintroduced into the riser, thereby establishing a circulation of polymer between the riser and the downcomer.

In some embodiments and in the first polymerization zone (riser), fast fluidization conditions are established by feeding a gas mixture made from or containing one or more alpha-olefins at a velocity higher than the transport velocity of the polymer particles. In some embodiments, the velocity of the gas mixture is between 0.5 and 15 m/s, alternatively between 0.8 and 5 m/s. As used herein, the terms “transport velocity” and “fast fluidization conditions” are as defined in “D. Geldart, Gas Fluidisation Technology, page 155 et seq., J. Wiley & Sons Ltd., 1986”.

In the second polymerization zone (downcomer), the polymer particles flow under the action of gravity in a densified form, thereby achieving high values of density of the solid (mass of polymer per volume of reactor) and approaching the bulk density of the polymer. As used herein, the term “densified form” of the polymer indicates that the ratio between the mass of polymer particles and the reactor volume is higher than 80% of the “poured bulk density” of the polymer. In the downcomer, the polymer flows downward in a plug flow and small quantities of gas are entrained with the polymer particles.

In some embodiments, the two interconnected polymerization zones are operated such that the gas mixture coming from the riser is totally or partially prevented from entering the downcomer by introducing into the upper part of the downcomer a liquid stream, a gas stream, or a combined liquid/gas stream, denominated “barrier stream”, having a composition different from the gaseous mixture present in the riser. In some embodiments, one or more feeding lines for the barrier stream are placed in the downcomer close to the upper limit of the volume occupied by the polymer particles flowing downward in a densified form.

In some embodiments, this liquid/gas mixture fed into the upper part of the downcomer partially replaces the gas mixture entrained with the polymer particles entering the downcomer. The partial evaporation of the liquid in the barrier stream generates in the upper part of the downcomer a flow of gas, which moves counter-currently to the flow of descending polymer, thereby acting as a barrier to the gas mixture coming from the riser and entrained among the polymer particles. In some embodiments, the liquid/gas barrier fed to the upper part of the downcomer is sprinkled over the surface of the polymer particles. In some embodiments, the evaporation of the liquid provides the upward flow of gas.

In some embodiments, the feed of the barrier stream causes a difference in the concentrations of monomers or hydrogen (molecular weight regulator) inside the riser and the downcomer.

In some embodiments, the polymerization process and apparatus are as described in European Patent No. EP 1012195.

In some embodiments, the BOPP film is mono or multilayer, wherein the other layers are made from or containing the same copolymer or one or more different polyolefins. In some embodiments, the BOPP film is further made from or containing additives for the film manufacturing, alternatively for packaging applications. In some embodiments, the additives are selected from the group consisting of anti-oxidants, process stabilizers, slip agents, antistatic agents, antiblock agents, and antifog agents. In some embodiments, the present disclosure provides a process for preparing BOPP films including the steps of: (i) extruding mono or multilayer film; and (ii) stretching the film longitudinally and transversally, that is, biaxially. In some embodiments, the BOPP film consists of the copolymer of propylene and ethylene.

The following examples are given to illustrate, not to limit, the present disclosure.

### EXAMPLES

Melting temperature was measured according to ISO 11357-3.

Determination of ethylene (C₂) content by NMR in a propylene ethylene copolymer

¹³C NMR spectra were acquired on a Bruker AV-600 spectrometer equipped with cryoprobe, operating at 160.91 MHz in the Fourier transform mode at 120° C.

The peak of the SBB carbon (nomenclature according to “Monomer Sequence Distribution in Ethylene-Propylene Rubber Measured by ¹³C NMR. 3. Use of Reaction Probability Mode ” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing ¹H-¹³C coupling. 512 transients were stored in 32K data points, using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:

PPP=100 Tββ/S PPE=100 Tβδ/S EPE=100 Tδδ/S

PEP=100 Sββ/S PEE=100 Sβδ/S EEE=100 (0.25 Sγδ+0.5 Sδδ)/S

S=Tββ+Tβδ+Tδδ+Sββ+Sβδ+0.25 Sγδ+0.5 Sββ

The molar percentage of ethylene content was evaluated using the following equation: E % mol=100*[PEP+PEE+EEE]

The weight percentage of ethylene content was evaluated using the following equation:

$$E \% wt . = \frac{1 \; 00 * E \% mol * MWE}{E \% mol * MWE + P \% mol * MWP}$$

where P % mol was the molar percentage of propylene content while MWE and MWP were the molecular weights of ethylene and propylene, respectively.

The product of reactivity ratio r1r2 was calculated according to Carman (C.J. Carman, R.A. Harrington and C.E. Wilkes, Macromolecules, 1977; 10, 536) as:

$${r}_{1} {r}_{2} = 1 + ( \frac{E E E + P E E}{P E P} + 1 ) - ( \frac{P}{E} + 1 ) {( \frac{E E E + P E E}{P E P} + 1 )}^{0.5}$$

The tacticity of Propylene sequences was calculated as mm content from the ratio of the PPP mm T_{ββ} (28.90-29.65 ppm) and the whole T_{ββ} (29.80-28.37 ppm).

Ethylene was measured on the total composition. The ethylene content of the propylene ethylene copolymer, designated component B) in the following equation, was calculated by using the amount of component B), according to the following equation:

$${C}_{2 t o t} = {C}_{2 B} X wt \% compB / 100.$$

### Xylene-soluble (XS) Fraction at 25° C.

### Solubility in Xylene at 25° C.

Xylene Solubles was measured according to ISO 16 152-2005; with solution volume of 250 ml, precipitation at 25° C. for 20 minutes, 10 minutes of which, with the solution in agitation (magnetic stirrer), and drying at 70°

### Melt Flow Rate (MFR)

Measured according to ISO 1133-1:2012 at 230° C. with a load of 2.16 kg, unless otherwise specified.

### Preparation of the Cast Film Specimens

A film was prepared by extruding the polymer in a single screw Collin extruder (length/diameter ratio of screw: 25) at a film drawing speed of 7 m/min. and a melt temperature of 210-250° C.

### Preparation of the BOPP Film Specimens

The cast films were stretched longitudinally and transversally, that is, biaxially, by a factor 4 with a TM Long film stretcher at 150° C.

### Haze:

Determined on cast films or BOPP films. The measurement was carried out on a 50×50 mm portion cut from the central zone of the film.

The instrument used for the test was a Gardner photometer with Haze-meter UX-10 equipped with a G.E. 1209 lamp and filter C. The instrument calibration was made by carrying out a measurement in the absence of the sample (0% Haze) and a measurement with intercepted light beam (100% Haze).

### Tensile Modulus (MET)

Measured according to ASTM D 882-18

### Example 1

### Preparation of the Solid Catalyst Component

Into a 500 mL four-necked round flask, purged with nitrogen, 250 mL of TiCl₄ were introduced at 0° C. While stirring, 10.0 g of microspheroidal MgCl₂·2.5C₂H₅OH, having an average particle size of 47 μm, (prepared by thermally dealcoholating a starting adduct obtained according to the procedure of example 1 of Patent Cooperation Treaty Publication No. WO2012/084735) and an amount of diethyl 2,3-diisopropylsuccinate in racemic form, to provide a Mg/succinate molar ratio of 12 were added. The temperature was raised to 100° C. and maintained for 60 min. After siphoning, fresh TiCl₄ and an amount of 9,9-bis(methoxymethyl)fluorine (bMMF), thereby providing a Mg/(bMMF) molar ratio of 12, were added. The temperature was raised to 90° C. and maintained for 30 min. After siphoning, the treatment with TiCl₄ was repeated at 90° C. for 30 min. The solid was washed six times with anhydrous hexane (6×100 ml) at 60° C. and finally dried.

### Prepolymerization Treatment

The solid catalyst component was contacted with triethyl aluminum (TEAL), in the absence of external electron donors. The mixture was subjected to prepolymerization by suspending the mixture in liquid propylene at 20° C. for about 5 minutes, before introducing the suspension into the polymerization reactor.

### Polymerization

The polymerization was carried out in gas-phase polymerization reactor having two interconnected polymerization zones, a riser and a downcomer, as described in European Patent No. EP1012195. The two interconnected polymerization zones were operated such that the gas mixture coming from the riser was totally or partially prevented from entering the downcomer by a liquid stream, a gas stream, or a combined liquid/gas stream, denominated “barrier stream”, having a composition different from the gaseous mixture present in the riser, introducing into the upper part of the downcomer.

The main precontact, prepolymerization, and polymerization conditions as well as the quantities of monomers and hydrogen fed to the polymerization reactor are reported in Table 1.

TABLE 1

| | Example | | Ex 1 |
|---|---|---|---|
| PRECONTACT | | | |
| | Temperature | ° C. | 15 |
| | Residence Time | min | 16 |
| | TEAL/catalyst | wt/wt | 5 |
| | TEAL/Ext. Donor | g/g | NO DONOR |
| PREPOLYMERIZATION | | | |
| | Temperature | ° C. | 25 |
| | Residence Time | min | 12 |
| POLYMERIZATION | | | |
| Component A | | | |
| | Temperature | bar-g | 70 |
| | Pressure | bar-g | 27 |
| | Residence Time | min | 90 |
| | Split holdup riser | wt % | 40 |
| | Split holdup downcomer | wt % | 60 |
| | C₂/C₂⁻ + C₃ riser | mol/mol | 0.003 |
| | C₂/C₂⁻ + C₃ downcomer | mol/mol | 0.007 |
| | H₂/C₃ riser | mol/mol | 0.010 |

C₂=ethylene; C₃=propylene:
   The properties of the polymer of example 1 are reported in Table 2.

TABLE 2

| | | Ex 1 | Comp Ex 2 |
|---|---|---|---|
| MFR | g/10 min | 3.6 | 3.4 |
| Xylene solubles at 25° C. | Wt % | 5.0 | 4.0 |
| Ethylene content | Wt % | 0.9 | 0 |
| Haze on 50μ cast film | % | 5.7 | 4.6 |
| BOPP film | | | |
| MET tang MD | MPa | 2700 | 2765 |
| Haze | % | 0.23 | 0.23 |

Comparative example 2 was a bimodal homopolymer, which was commercially available from Lyondellbasell under the tradename Moplen HP525J.

Polymer of example 1 and comparative example 2 were tested for the stretchability.

This test used a pilot line Film Stretcher BOPP KARO IV BRÜCKNER. 10 plaques of 70×70×1 mm were conditioned to 150° C. for 50 s. The plaques were stretched to a 20μ thick film of 490×490 mm at a 150° C. The number of breaks were recorded. The temperature was reduced to 5° C. The procedure was repeated until 10 plaques broke.

The results of the test are reported in Table 3.

TABLE 3

| | Ex 1 | Comp ex 2 |
|---|---|---|
| temperature | breaks | Breaks |
| 150° C. | 0 | 0 |
| 145° C. | 0 | 7 |
| 140° C. | 7 | 10 |
| 135° C. | 10 | 10 |

Tensile strength

Tensile strength to stretch at high temperature (from 150° C. down to minimum temperature). Those values, measured as average for each temperature and average of both directions, represent stresses to stretch materials at various temperatures. Strength at yield at various temperatures was measured. The results are reported in Table 4.

TABLE 4

| | Ex 1 | Comp ex 2 |
|---|---|---|
| temperature | Strength at yield (MPa) | Strength at yield (MPa) |
| 150° C. | 0.70 | 0.92 |
| 145° C. | 0.90 | 1.13 |
| 140° C. | 1.25 | 1.35 |
| 135° C. | 1.43 | — |

1. A biaxially oriented polypropylene (BOPP) film comprising:
a copolymer of propylene and-ethylene having:
i) the content of ethylene derived units, measured by 13C NMR, ranging from 0.5 wt % to 2.2 wt %, based upon the total weight of the copolymer;
ii) a xylene soluble fraction at 25° C. ranging from 4.3 wt % to 6.5 wt %, based upon the total weight of the copolymer; and
iii) a melt flow rate, MFR, measured according to ISO 1133-1:2012 at 230° C. with a load of 2.16 kg, ranging from 0.5 g/10 min to 7.0 g/10 min;

2. The biaxially oriented polypropylene (BOPP) film according to claim 1, wherein the content of ethylene derived units, measured by ¹³C NMR, in the copolymer of propylene and ethylene ranges from 0.6 wt % to 1.8 wt.

3. The biaxially oriented polypropylene (BOPP) film according to claim 1, wherein the xylene soluble fraction at 25° C. units in the copolymer of propylene and ethylene ranges from 4.6 wt % to 6.1 wt %.

4. The biaxially oriented polypropylene (BOPP) film according to claim 1, wherein, in the copolymer of propylene and ethylene, the melt flow rate, MFR, measured according to ISO 1133-1:2012 at 230°° C. with a load of 2.16 kg, ranges from 1.0 g/10 min to 6.0 g/10 min.

5. The biaxially oriented polypropylene (BOPP) film according to claim 1, wherein the content of ethylene derived units in the copolymer of propylene and ethylene ranges from 0.7 wt % to 1.4 wt %.

6. The biaxially oriented polypropylene (BOPP) film according to claim 1, wherein the xylene soluble fraction at 25° C. units in the copolymer of propylene and ethylene ranges from 4.8 wt % to 5.7 wt %.

7. The biaxially oriented polypropylene (BOPP) film according to claim 1, wherein, in the copolymer of propylene and ethylene, the melt flow rate, MFR, measured according to ISO 1133-1:2012 at 230°° C. with a load of 2.16 kg, ranges from 1.5 g/10 min to 4.5 g/10 min.

8. A process for preparing a biaxially oriented polypropylene (BOPP) film comprising the steps of:
(i) extruding mono or multilayer film; and then
(ii) stretching the film longitudinally and transversally, wherein the film comprises the copolymer of propylene and ethylene according to claim 1.

9. (canceled)

10. The biaxially oriented polypropylene (BOPP) film according to claim 1, wherein the film is multilayer, having at least one layer comprising the copolymer of propylene and ethylene.
